(19) United States
(12) Patent Application Publication
(10) Pub. No.: US 2008/0136966 A1
(43) Pub. Date: Jun. 12, 2008

(54) Frame Synchronizer, Synchronization Method of Frame Synchronizer, Image Processing Apparatus, and Frame Synchronization Program

(76) Inventor: Kazunori Hashimoto, Tokyo (JP)

Correspondence Address: DRINKER BIDDLE & REATH (DC), 1500 K STREET, N.W., SUITE 1100, WASHINGTON, DC, 20005-1209, US

(21) Appl. No.: 11/919,249

(22) PCT Filed: Apr. 21, 2006
(86) PCT No.: PCT/JP2006/308920

§ 371 Date: Nov. 30, 2007

(30) Foreign Application Priority Data
Apr. 28, 2005 (JP) 2005-13114

(51) Int. Cl. H04N 5/04

(52) U.S. Cl. 348/500; 348/E05.009

(57) ABSTRACT

Disclosed is a frame synchronizer 10 capable of suppressing the generation of a jaggy phenomenon without deteriorating image quality. The frame synchronizer comprises a buffer memory for sequentially storing an input video data stream supplied in synchronization with a first synchronization signal, and a memory control section for reading video data from the buffer memory in synchronization with a second synchronization signal. Before a remaining capacity of the buffer memory reaches a predetermined lower limit, the memory control section reads one field of first and second fields in an area starting from a predetermined start line and reads the other field in an area starting from a predetermined first start line, the first field containing pixel data on even number lines of each frame, and the second field containing pixel data on odd number lines of each frame. When the remaining capacity of the buffer memory reaches the predetermined lower limit, the memory control section reads only the other field in an area starting from a second start line that is shifted by one horizontal line from the predetermined first start line.

### TECHNICAL FIELD

The present invention relates to a frame synchronizer for converting a video signal synchronized with a synchronization signal input from an external signal source, into a video signal synchronized with another synchronization signal, and relates to technologies associated to the frame synchronizer.

### BACKGROUND ART

Encoders that perform digital-processing on video signals are widely integrated into recording/reproducing apparatus capable of recording video signals onto a high-capacity recording medium such as an optical disk, or into communication devices capable of receiving broadcast signals and/or radio signals. In the NTSC (National Television System Committee) system, for example, three types of synchronization signals (i.e., a vertical synchronization signal, a horizontal synchronization signal and a color synchronization signal) are multiplexed into an analog video signal. To perform digital-processing on such an analog video signal, it is required that an encoder performs an A/D-conversion on an analog video signal, which is input in synchronization with the multiplexed synchronization signal, to generate a digital video signal, and converts the generated digital video signal into a video signal synchronizing with a reference clock signal (i.e., a reference synchronization signal inside the encoder) for performing digital-processing. This conversion processing that is synchronization processing is performed by a frame synchronizer. This kind of frame synchronizer has a buffer memory (not illustrated) which temporarily stores digital video signals, and has a memory control circuit (not illustrated) which controls writing and reading data for the buffer memory. A prior art of this kind of frame synchronizer is disclosed in Japanese Patent Application Publication No. 2001-309202.

The frame synchronization of the prior art, however, executes synchronization processing on a frame to frame basis, so that the buffer memory needs to have a memory storage capacity of at least two frames. In the course of developing a frame synchronizer capable of executing synchronization processing on a field to field basis in order to provide less storage capacity of the buffer memory, the present inventor discovered that, when the frame synchronizer of the prior art is used, a phenomenon (called “jaggy”) where edges of displayed images appears jagged occurs. This phenomenon will now be described. In the NTSC system, each frame of the video signal is comprised of a first field containing pixel data on odd number horizontal lines (hereinafter referred to as “top field”), and a second field containing pixel data on even number horizontal lines (hereinafter referred to as “bottom field”). Then, the top field and bottom field are alternately stored in the buffer memory of the frame synchronizer, in a specific order such as top field T1, bottom field B1, top field T2, bottom field B2, . . . . In the case when the buffer memory sequentially stores digital video signals in synchronization with the horizontal synchronization signal which are input from the external signal source, and the memory control circuit reads the video signals from the buffer memory in synchronization with the horizontal synchronization signal of the reference clock signal, the frequency of the external vertical synchronization signal and the frequency of the vertical synchronization signals inside the synchronizer can be shifted from each other. The frequency shift can keep for a predetermined time, thus causing a buffer overflow or underflow in the buffer memory.

In order to avoid the buffer overflow or underflow, the memory control circuit can skip one of the top field and bottom field to read the other field when the remaining capacity of the buffer memory becomes too small, that is, when judging that the occurrence probability of the buffer overflow is high. As FIG. 1B shows, when judging that the occurrence probability of the overflow is high at time T1, the memory control circuit can skip the top field T2 and read the bottom field B2 from the buffer memory. On the other hand, when the remaining capacity of the buffer memory becomes too large, that is, when judging that the occurrence probability of the buffer underflow in the buffer memory is high, the memory control circuit can read one of the top field and bottom field repeatedly from the buffer memory. As shown in FIG. 1C as an example, when judging that the occurrence probability of the buffer underflow is high at time T2, the memory control circuit can read the bottom field B2 repeatedly from the buffer memory.

As shown FIGS. 1B and 1C, however, the skipping of the top field T2 or the repeated reading of the bottom field B2 cause the shift of the positions of the top field and bottom field along the time axis in each frame. This position shift can be one of the causes of the jaggy where the edge of the image in an oblique direction appears jagged. For example, as FIG. 2 shows, when the character “A” having image edges in oblique directions is displayed, a jagged edge 114b can appear as illustrated in the enlarged view 115.

A possible method for reducing such a jaggy is of extracting a low spatial frequency component of the image edge portion by using a low pass filter or an interpolation filter. However, there is a problem with the possible method that the contour of the image edge portion becomes blurred, thereby causing image quality to be deteriorated.

### DISCLOSURE OF THE INVENTION

In view of the foregoing, it is an object of the present invention to provide a frame synchronizer, synchronization method, image processing apparatus and frame synchronization program for suppressing the generation of the above mentioned jaggy. It is another object of the present invention to provide a frame synchronizer, synchronization method, image processing apparatus and frame synchronization program that are capable of providing less capacity required for a buffer memory and reducing power consumption, as well as suppressing the generation of the above mentioned jaggy.

According to a first aspect of the present invention, there is provided a frame synchronizer for converting an input video data stream supplied in synchronization with a first synchronization signal, into an output video data stream synchronized with a second synchronization signal. The frame synchronizer comprises a buffer memory for storing the input video data stream; and a memory control section for reading output video data from the buffer memory in synchronization with the second synchronization signal. Before a remaining capacity of the buffer memory reaches a predetermined lower limit, the memory control section reads one field of a first field and a second field in an area starting from a predetermined start line, and reads the other field in an area starting from a predetermined first start line, the first field containing pixel data on even number horizontal lines of each frame of the input video data stream, and the second field containing pixel data on odd number horizontal lines of each frame. When the remaining capacity reaches the predetermined lower limit, the memory control section reads only the other field in an area starting from a second start line that is shifted by one horizontal line from the predetermined first start line.

According to a second aspect of the present invention, there is provided an image processing apparatus comprising the frame synchronizer according; and an encoder for encoding an output video data stream converted by the frame synchronizer.

According to a third aspect of the present invention, there is provided a synchronization method for a frame synchronizer comprising a buffer memory for storing an input video data stream supplied in synchronization with a first synchronization signal to convert the input video data stream into an output video data stream synchronized with a second synchronization signal by reading video data from the buffer memory in synchronization with the second synchronization signal. The synchronization method comprises the steps of: (a) before a remaining capacity of the buffer memory reaches a predetermined lower limit, reading one field of a first field and a second field in an area starting from a predetermined start line, and reading the other field in an area starting from a predetermined first start line, the first field containing pixel data on even number horizontal lines of each frame of the input video data stream, and the second field containing pixel data on odd number horizontal lines of each frame; and (b) when the remaining capacity reaches the predetermined lower limit, reading only the other field in an area starting from a second start line that is shifted by one horizontal line from the predetermined first start line.

According to a fourth aspect of the present invention, there is provided a frame synchronization program for causing a microprocessor to execute synchronization processing to convert an input video data stream into an output video data stream synchronized with a second synchronization signal in a frame synchronizer having a buffer memory for storing the input video data stream supplied in synchronization with a first synchronization signal by reading video data from the buffer memory in synchronization with the second synchronization signal. The synchronization processing comprises the steps of: (a) before a remaining capacity of the buffer memory reaches a predetermined lower limit, reading one field of a first field and a second field in an area starting from a predetermined start line, and reading the other field in an area starting from a predetermined first start line, the first field containing pixel data on even number horizontal lines of each frame of the input video data stream, and the second field containing pixel data on odd number horizontal lines of each frame; and (b) when the remaining capacity reaches the predetermined lower limit, reading only the other field in an area starting from a second start line that is shifted by one horizontal line from the predetermined first start line.

### BRIEF DESCRIPTION OF THE DRAWINGS

FIGS. 1A, 1B and 1C are diagrams depicting an operation of a conventional frame synchronizer;

FIG. 2 is a diagram depicting a jaggy phenomenon;

FIG. 3 is a block diagram depicting a configuration of an image processing apparatus which includes a frame synchronizer according to an embodiment of the present invention;

FIGS. 4A, 4B and 4C are diagrams depicting only active lines of top fields, respectively;

FIGS. 5A, 5B and 5C are diagrams depicting only active lines of bottom fields, respectively;

FIG. 6 is a flow chart depicting an example of synchronization control processing of the embodiment;

FIG. 7 is a flow chart depicting an example of a field drop procedure;

FIG. 8 is a flow chart depicting an example of a field insertion procedure;

FIG. 9 is a flow chart depicting a line selection procedure;

FIGS. 10A and 10B are diagrams depicting bottom fields and top fields as examples;

FIGS. 11A and 11B are diagrams depicting conventional synchronization control processing;

FIGS. 12A and 12B are diagrams depicting synchronization control processing of the embodiment;

FIGS. 13A and 13B are diagrams depicting conventional synchronization control processing;

FIGS. 14A and 14B are diagrams depicting synchronization control processing of the embodiment;

FIG. 15 is a block diagram depicting a configuration of an image processing apparatus which includes a frame synchronizer according to a modification of the embodiment; and

FIG. 16 is a flow chart depicting an example of synchronization control processing of the modification.

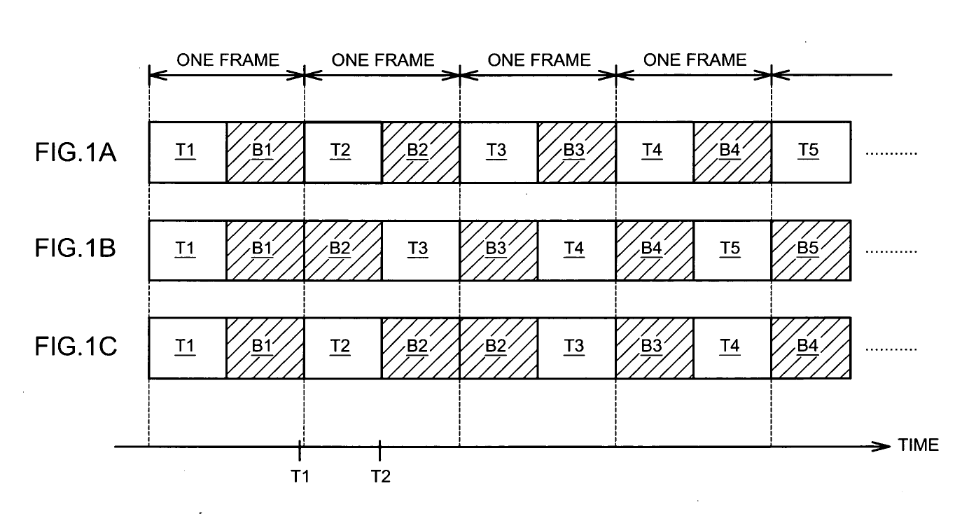

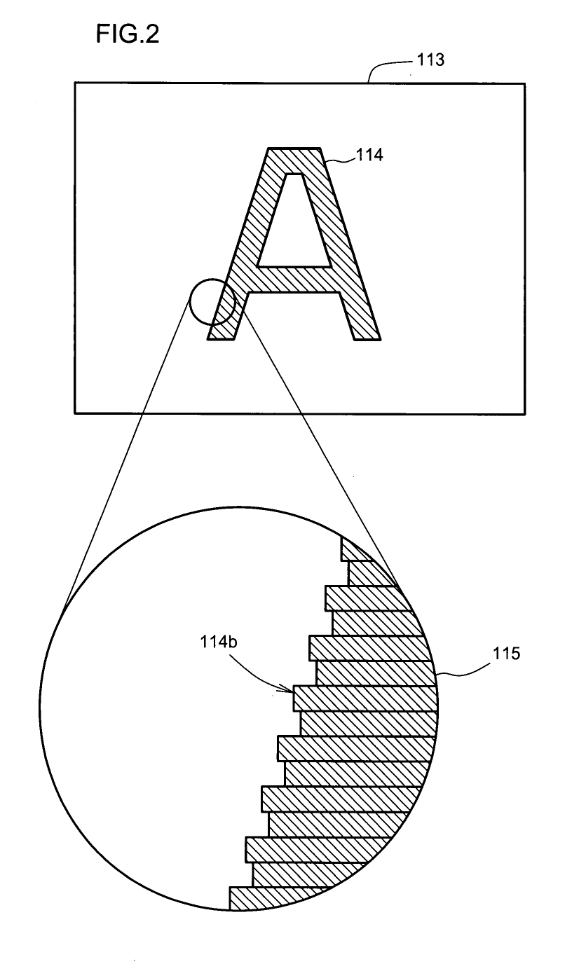

### MODE FOR CARRYING OUT THE INVENTION

Various embodiments of the present invention will now be described.

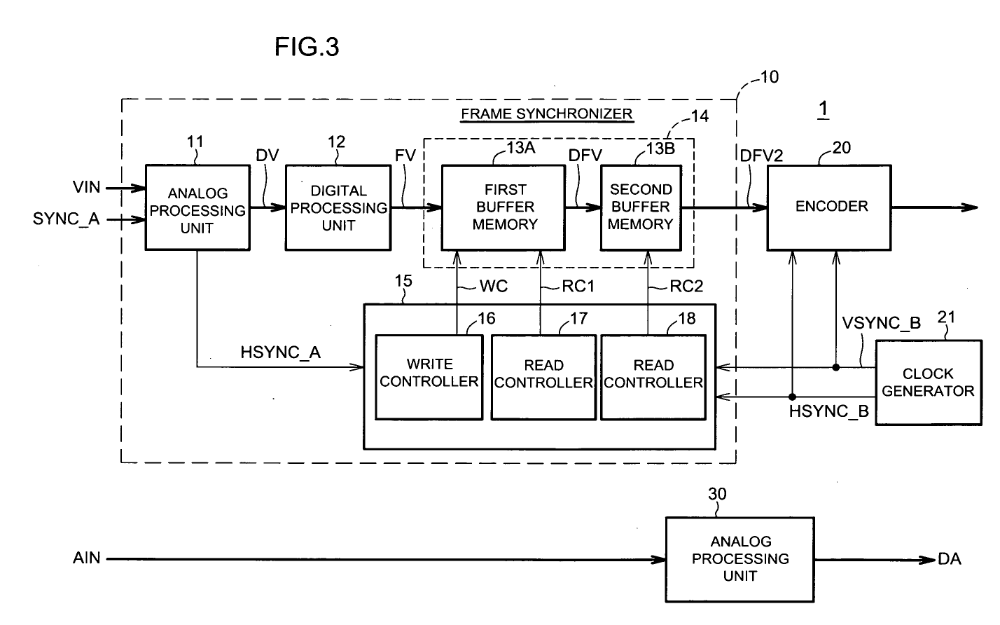

FIG. 3 is a block diagram depicting a configuration of an image processing apparatus 1 that comprises a frame synchronizer 10 according to an embodiment of the present invention. This image processing apparatus 1 comprises the frame synchronizer 10, an encoder 20, a clock generator 21 and an analog processing unit 30. The frame synchronizer 10 includes an analog processing unit 11, a digital processing unit 12, a buffer memory 14 and a controller (memory control section) 15. The buffer memory 14 further includes a first buffer memory (field memory) 13A and a second buffer memory (line memory) 13B.

A synchronization signal SYNC_A and an analog video signal VIN synchronized with a synchronization signal SYNC_A are supplied to the frame synchronizer 10. In the present embodiment, the analog video signal VIN and the synchronization signal SYNC_A are separately supplied to the frame synchronizer 10. Alternatively, an NTSC signal in which the synchronization signal SYNC_A is superimposed on the analog video signal VIN can be supplied to the frame synchronizer 10. The analog processing unit 11 amplifies the analog video signal VIN, performs filtering on the amplified signal, and performs A/D-conversion on the filtered and amplified signal. The analog processing unit 11 further extracts a horizontal synchronization signal HSYNC_A from the synchronization signal SYNC_A and supplies the signal HSYNC_A to the controller 15. The digital processing unit 12 converts the digital video signal DV supplied from the analog processing unit 11 into a format data stream (input video data stream) FV. The format data stream includes pixel data and synchronization information (timing references) which are compliant with an output format such as ITU-R BT. 656 and includes a top field and a bottom field that are arranged alternately. As described above, the top field is a field comprised of pixel data on odd number horizontal lines of each frame, and the bottom field is a field comprised of pixel data on even number horizontal lines of each frame. In the present embodiment, it is assumed for convenience that multiplexed synchronization information is added to each top field and bottom field.

The controller 15 includes a write controller 16 that performs write control of the first buffer memory 13A with respect to a data stream FV; a read controller 17 that performs read control of the first buffer memory 13A with respect to a data stream DFV; and a read controller 18 that performs read control of the second buffer memory 13B with respect to a data stream DFV. The controller 15 can be constructed by an integrated circuit that includes a microprocessor, ROM (Read Only Memory), RAM (Random Access Memory), timer circuit, internal bus and input/output interfaces. The ROM stores various programs for causing the microprocessor to execute a part of or all of the synchronization control processing of the present embodiment. The write controller 16, read controller 17, and read controller 18 can be implemented by hardware or may be implemented by programs stored in the ROM.

The first buffer memory 13A is a two-port memory that has a storage capacity of at least one field. For the reasons described later, since the first buffer memory 13A need not have a storage capacity of four fields that is two frames unlike prior arts, the storage capacity required for the buffer memory 14 can be reduced. The write controller 16 supplies a write control signal WC to the first buffer memory 13A, and sequentially writes the data stream FV into a storage area specified by write addresses of the write control signal WV. The read controller 17 supplies a read control signal RC1 to the first buffer memory 13A, reads pixel data from a storage area specified by read addresses of the read control signal RC1, and supplies the read pixel data to the second buffer memory 13B.

The controller 15 constantly monitors the remaining capacity of the first buffer memory 13A based on a vertical synchronization signal VSYNC_B and a horizontal synchronization signal HSYNC_A that are supplied from the clock generator 21, and executes a field drop procedure or field insertion procedure as described later when the remaining capacity reaches a predetermined upper limit or lower limit, thereby to prevent a buffer overflow or underflow in the first buffer memory 13A.

All horizontal lines of the top field do not always contain image data. This is the same case as those of the bottom field. In the NTSC system, for example, the image data can be included in 244 active lines of 262 horizontal lines of the top field, and the image data can be included in 243 active lines of 263 horizontal lines of the bottom field. All of the active lines need not be used for image processing. It is typically preferable to use only a multiple of a power of 2 horizontal lines (hereinafter referred to as “selected active lines”) for image processing, which is suitable for digital processing. In the NTSC system, for example, 240 selected active lines which is 15 times 16 (=24) of 244 active lines of the top field, can be used for image processing.

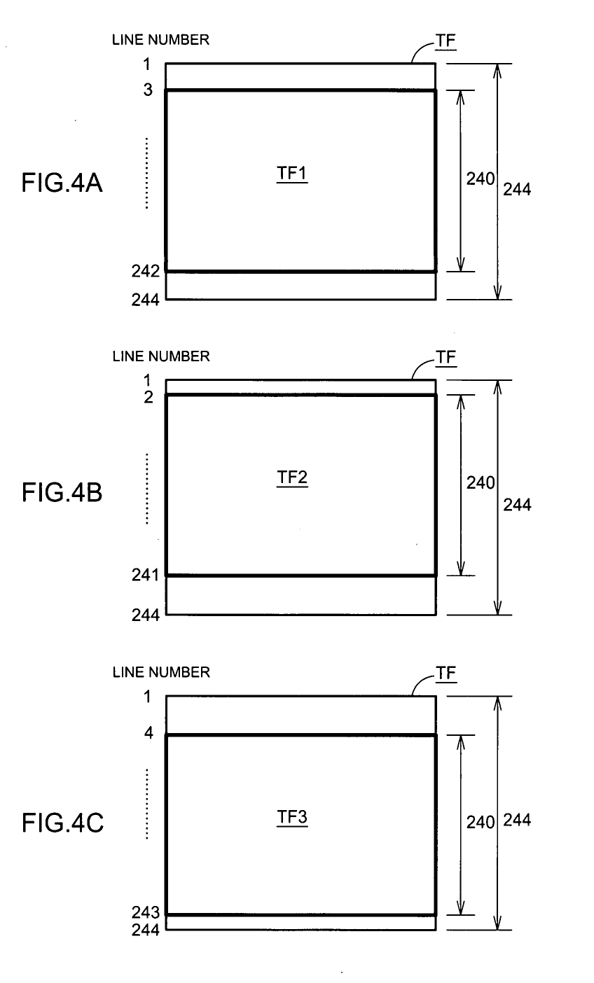

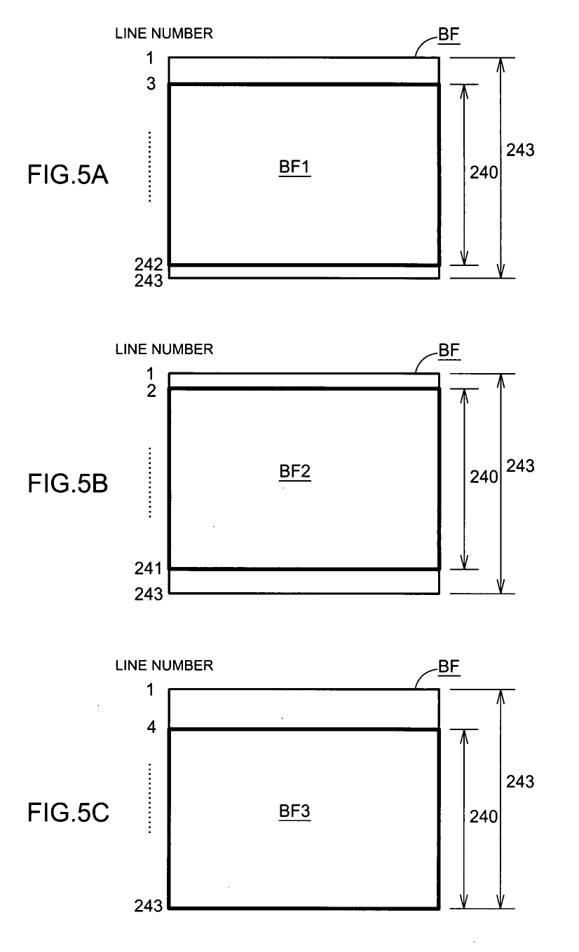

The second buffer memory 13B is comprised of, for example, an FIFO memory which stores the top field or the bottom field of the data stream supplied from the first buffer memory 13A by 2 or 3 horizontal lines. The second buffer memory 13B outputs the data stream DFV2 during a period when an enable signal is supplied as the read control signal RC2, and stops to output the data stream DFV2 during a period when a disable signal is supplied as the read control signal RC2. The second buffer memory 13B can specify the selected active lines out of the active lines of the top field or the bottom field in accordance to the read control signal RC2, and can supply the data stream of the selected active lines to the encoder 20. FIGS. 4A, 4B and 4C are diagrams depicting only active lines of the top field TF. FIGS. 5A, 5B and 5C are diagrams depicting only active lines of the bottom field BF.

In FIG. 4A, the third active line (read start line) to the 242^{nd} active line (end line) are selected as the selected active lines out of the 244 active lines, and constitute the selected active area TF1. In FIG. 4B, the second active line (read start line) which is shifted one horizontal line upward from the third active line, to the 241^{st} active line constitutes the selected active area TF2. In FIG. 4C, the fourth active line (read start line) which is shifted one horizontal line downward from the third active line, to the 243^{rd} active line constitute the selected active area TF3. When the top field TF is supplied to the encoder 20, the second buffer memory 13B is capable of operating in one of the three types of operation modes corresponding to respective FIGS. 4A to 4C in accordance with the read control signal RC2. In other words, the second buffer memory 13B has a function to select and output the data stream DFV2 in one of the selected active areas TF1, TF2 and TF3 shown in FIGS. 4A to 4C in accordance with the selected operation mode.

In FIG. 5A, on the other hand, the third active line (read start line) to the 242^{nd} active line (end line) of the 243 active lines are selected as the selected active lines, and constitute the selected active area BF1. In FIG. 5B, the second active line (read start line) which is shifted one horizontal line upward from the third active line, to the 241^{st} active line constitute the selected active area BF2. In FIG. 5C, the fourth active line (read start line) which is shifted one horizontal line downward from the third active line, to the 243^{rd} active line constitute the selected active area BF3. When the bottom field BF is supplied to the encoder 20, the second buffer memory 13B is capable of operating in one of three types of operation modes corresponding to respective FIGS. 5A to 5C in accordance with the read control signal RC2. The second buffer memory 13B has a function to select and output the data stream DFV2 in one of the selected active area BF1, BF2 and BF3 shown in FIGS. 5A to 5C in accordance with the selected operation mode.

The encoder 20 is a block that encodes the format data stream DFV2 supplied from the frame synchronizer 10, and operates in synchronization with the horizontal synchronization signal HSYNC_B and the vertical synchronization signal VSYNC_B that are supplied from the clock generator 21. This encoder 20 can be a block that, for example, performs compression encoding in accordance with MPEG (Moving Picture Experts Group) standard, a known format conversion, image processing or modulation, no limitation thereto intended.

The analog processing unit 30 is a block that processes an analog audio signal AIN supplied in synchronization with the analog video signal VIN, and operates in synchronization with a clock signal (not illustrated) supplied from the clock generator 21. Specifically, the analog processing unit 30 amplifies the analog audio signal AIN, performs filtering on the amplified signal, performs A/D-conversion on the filtered signal, and outputs the converted signal DA.

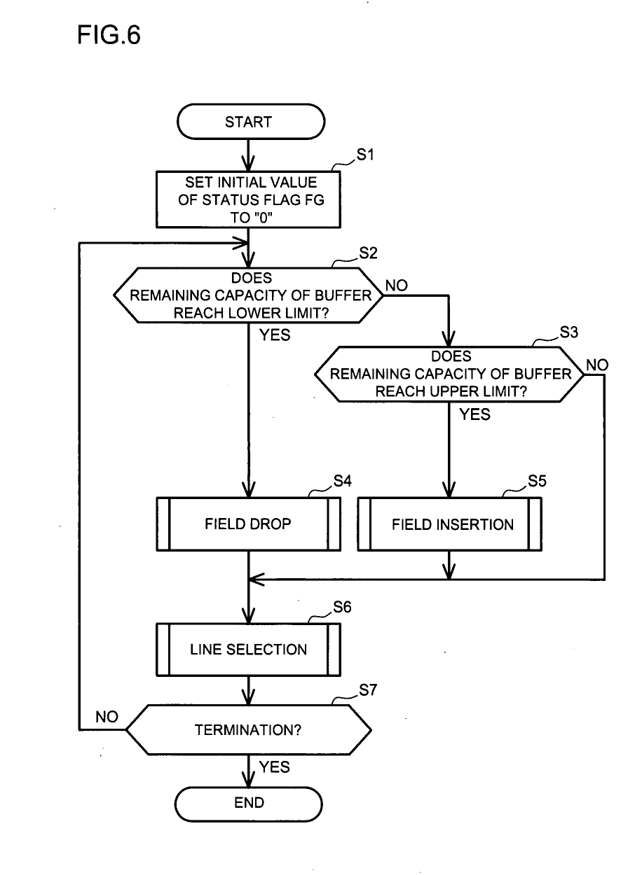

Control operations of the frame synchronizer 10 having the above configuration will now be described. FIGS. 6, 7 and 8 are flow charts depicting examples of processing procedures of a synchronization method of the present embodiment. Referring to FIG. 6, when the frame synchronizer 10 starts up, the controller 15 sets an initial value of a status flag FG to “0” and stores the initial value in an internal register (step S1). The analog video signal VIN and the synchronization signal SYNC_A are supplied to the frame synchronizer 10.

The controller 15 judges whether the remaining capacity of the first buffer memory 13A reaches a predetermined lower limit based on the horizontal synchronization signal HSYNC_A and the reference clock signal (vertical synchronization signal) VSYNC_B (step S2). When the frequency of the horizontal synchronization signal HSYNC_A inputted from an external signal source is different from a reference clock frequency (i.e., frequency of the horizontal synchronization signal HSYNC_B) inside the synchronizer due to such a cause as jitter, and continues to be higher than the reference clock frequency for some period of time, the remaining capacity of the first buffer memory 13A becomes less than the lower limit that indicates a warning of the generation of a buffer overflow. At this time, the controller 15 judges that the remaining capacity reaches the lower limit. The read controller 17 then executes the field drop procedure in which either one of the top field and the bottom field is skipped, and only the other field is read from the first buffer memory 13A (step S4).

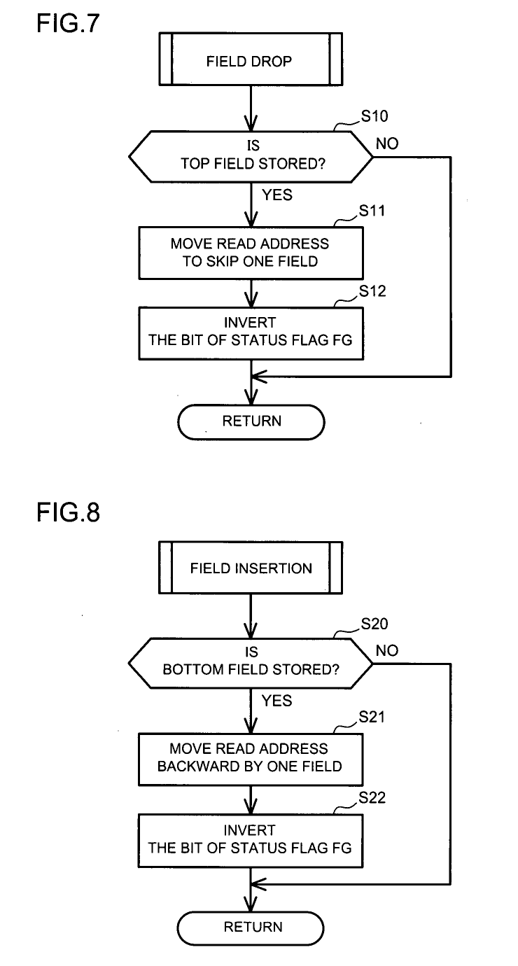

FIG. 7 is a flow chart depicting an example of the field drop procedure. As shown in FIG. 7 as an example, the top field is skipped and the bottom field is read from the first buffer memory 13A. Referring to FIG. 7, the read controller 17 judges whether or not the top field is stored in the first buffer memory 13A (step S10). When it is judged that the top field is not stored, the controller 15 does not execute the field drop procedure any more, and executes the line selection procedure (step S6 of FIG. 6). The line selection procedure will be described later.

When it is judged that the top field is stored in the first buffer memory 13A (step S10), the read controller 17 moves the read address from the address that indicates a leading portion of an area corresponding to the top field to skip one field (step S11). As a result, the read controller 17 skips over the storage area corresponding to the top field in the first buffer memory 13A to generate read addresses that specify the storage area corresponding to the bottom field. Then the controller 15 inverts the bit of the status flag FG (step S12). As a result, the value of the status flag FG changes from “0” to “1”. The controller 15 then returns the procedure to the main routine (FIG. 6).

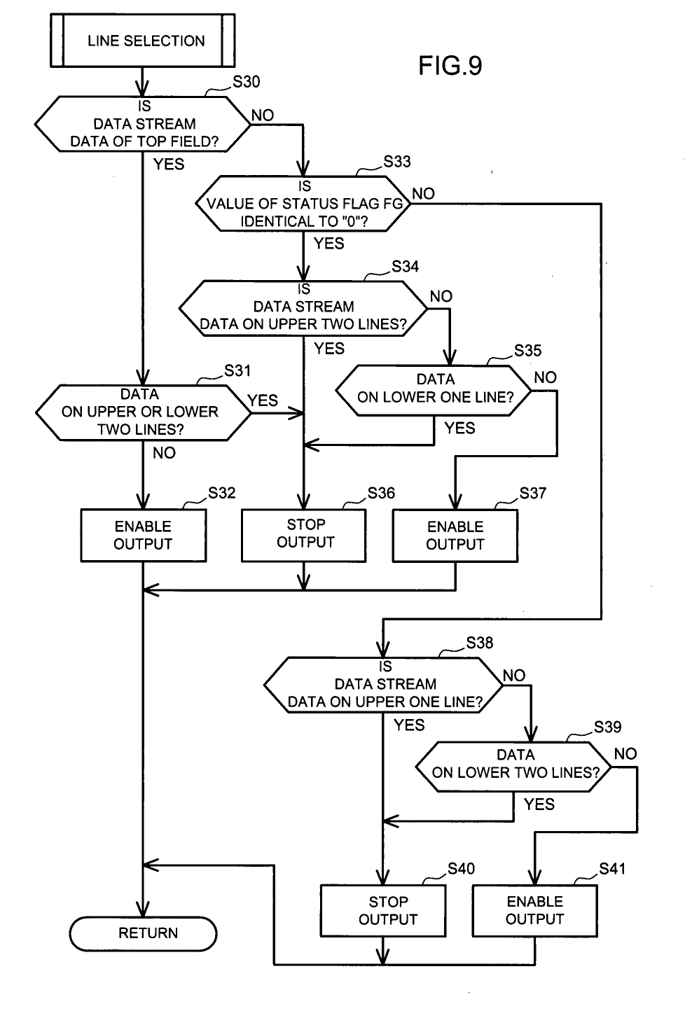

After the above-described field drop procedure (steps S11, S12) is executed, the line selection procedure (step S6) is executed by the read controller 18. FIG. 9 is a flow chart depicting an example of the line selection procedure. Referring to FIG. 9, the read controller 18 judges whether or not the data stream to be outputted by the second buffer memory 13B is data of the top field (step S30). Since the current status is a step immediately after the field drop procedure, the read controller 18 judges that the data stream is not data of the top field (step S30), and judges that the value of the status flag FG is not “0” (step S33).

In subsequent steps S38 to S41, the data stream of the selected active area BF2 shown in FIG. 5B is selectively supplied to the encoder 20. Specifically, in step S38, the read controller 18 judges whether or not the data stream is data on the upper one line of the bottom field BF (i.e., data on the first active line) (see FIG. 5B). When judging that this data stream is data on the upper one line, the read controller 18 stops output of the data stream by supplying a disable signal as the read control signal RC2 to the second buffer memory 13B (step S40). As a result, the data on the upper one line is skipped.

On the other hand, when judging that the data stream is not data on the upper one line in step S38, the read controller 18 further judges whether or not the data stream is data on the lower two lines (i.e., data on 242^{nd} or 243^{rd} active line) (step S39). When judging that the data stream is data on the lower two lines, the read controller 18 stops output of the data stream by supplying a disable signal as the read control signal RC2 to the second buffer memory 13B (step S40). As a result, the data on the lower two lines is skipped.

When judging that the data stream is not data on the lower two lines in step S39, the read controller 18 enables output of the data stream by supplying an enable signal as the read control signal RC2 to the second buffer memory 13B (step S41).

With reference again to FIG. 6, when the controller 15 judges that the remaining capacity does not reach the lower limit in step S2, the controller 15 further judges whether or not the remaining capacity reaches a predetermined upper limit (step S3). When the frequency of the horizontal synchronization signal HSYNC_A is not different from a reference clock frequency and continues to be lower than the reference clock frequency for some period of time, the remaining capacity of the first buffer memory 13A exceeds the upper limit that indicates a warning of the generation of a buffer underflow. At this time, the controller 15 judges that the remaining capacity reaches the upper limit. The read controller 17 then executes the field insertion procedure (step S5) to read one of the top field and the bottom field repeatedly from the first buffer memory 13A.

FIG. 8 is a flow chart depicting an example of the field insertion procedure. As shown in FIG. 8 as an example, the bottom field is repeatedly read from the first buffer memory 13A. Referring to FIG. 8, the read controller 17 judges whether or not the bottom field is stored in the first buffer memory 13A (step S20). When it is judged that the bottom field is not stored, the field insertion procedure is not executed, and the controller 15 executes the line selection procedure (step S6 of FIG. 6). The line selection procedure will be described later.

When judging that the bottom field is stored in the first buffer memory 13A (step S20), the read controller 17 move the read address backward by one field, and generates read addresses that indicates the leading portion of an area corresponding to the bottom field (step S21). As a result, the read controller 17 repeatedly generates the read addresses that specify the storage area corresponding to the bottom field in the first buffer memory 13A. Then the controller 15 inverts the bit of the status flag FG (step S22). As a result, the value of the status flag FG changes from “0” to “1”. The value is set to the initial value “1” when the bit of the value “1” is inverted. The controller 15 then returns the procedure to the main routine (FIG. 6).

After the above-described field insertion procedure (steps S21, S22) is executed, the line selection procedure (step S6) is executed by the read controller 18. As shown in FIG. 9, the read controller 18 judges that the output data of the second buffer memory 13B is not data of the top field (step S30), and that the value of the status flag FG is not “0” (step S33). In subsequent steps S38 to S41, the data stream of the selected active area BF2 shown in FIG. 5B is selectively supplied to the encoder 20. The procedures in steps S38 to S41 is executed as described above.

With reference again to FIG. 6, when the controller 15 judges that the remaining capacity of the first buffer memory 13A does not reach the lower limit or the upper limit in step S2 and S3, the line selection procedure (step S6) is executed. In this case, referring to FIG. 9, the read controller 18 judges whether or not the output data of the second buffer memory 13B is data of the top field (step S30). When judging that the data stream is the data of the top field, the data stream in the selected active area TF1 shown in FIG. 4A is selectively supplied to the encoder 20 in steps S31, S32 and S36. Specifically, in step S31, the read controller 18 judges whether the data stream is data on the upper or lower two lines of the top field (i.e., data on the first, second, 243^{rd} or 244^{th} active line). When judging that the data stream is data on the upper two lines, the read controller 18 stops the output of the data stream by supplying a disable signal as the read control signal RC2 to the second buffer memory 13B (step S36). As a result, data on the upper or lower two lines is skipped. On the other hand, when judging that the data stream is not data on the upper or lower two lines in step S31, the read controller 18 enables output of the data stream by supplying an enable signal to the second buffer memory 13B.

When judging that the data stream is not data of the top field in step S30, the read controller 18 further judges that the value of the status flag FG is “0” (step S33). Then, the data stream in the selected active area BF1 shown in FIG. 5A is selectively supplied to the encoder 20 in steps S34 to S37. Specifically, in step S34, the read controller 18 judges whether or not the data stream is data on the upper two lines of the bottom field BF (i.e., data on the first or second active line) (see FIG. 5A). When judging that the data stream is data on the upper two lines, the read controller 18 stops output of the data stream by supplying a disable signal as the read control signal RC2 to the second buffer memory 13B (step S36). As a result, the data for the upper two lines is skipped.

When judging that the data stream is not data on the upper two lines in step S34, the read controller 18 further judges whether or not this data stream is data on the lower one line (i.e., data on the 243^{rd} active line) (step S35). When judging that the data stream is data on the lower one line, the read controller 18 stops output of the data stream by supplying a disable signal as the read control signal RC2 to the second buffer memory 13B (step S36). As a result, data on the lower one line is skipped.

When judging that the data stream is not data on the lower one line in step S35, the read controller 18 enables output of the data stream by supplying an enable signal as the read control signal RC2 to the second buffer memory 13B (step S37).

With reference then to FIG. 6, the controller 15 judges whether or not the synchronization control is to be terminated (step S7). The controller 15 repeatedly executes steps S2 to S6 until it is judged that the synchronization control is to be terminated.

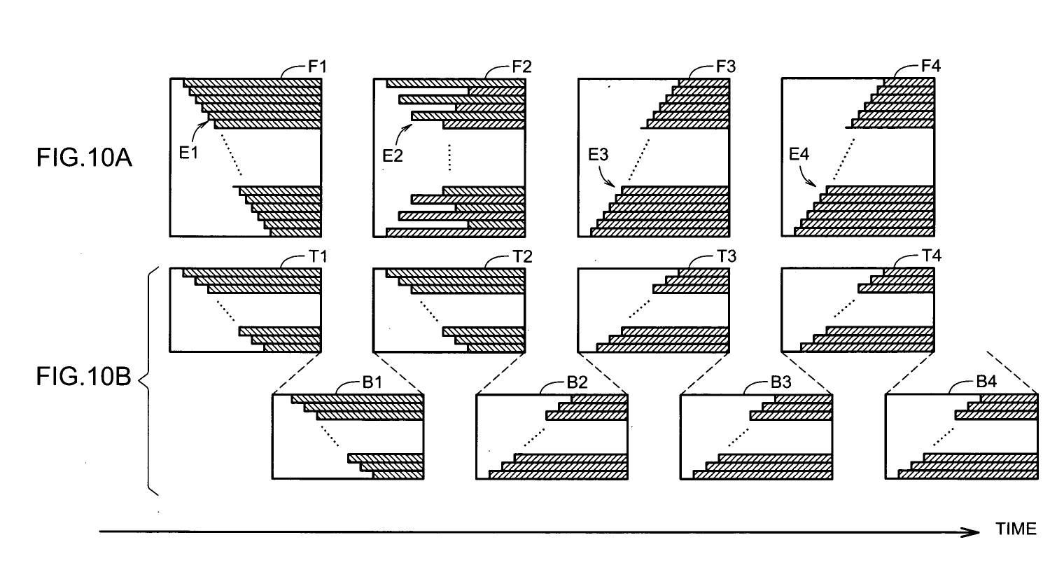

The above-described synchronization control enables the generation of jaggy to be reduced. This will be described with reference to FIGS. 10A, 10B, 11A, 11B, 12A, 12B, 13A, 13B, 14A and 14B. For example, as shown in FIG. 10A, frames F1, F2, F3, F4, . . . which have respective image edges E1, E2, E3, E4, . . . will be considered. As shown in FIG. 10B, a frame F1 is comprised of the top field T1 and the bottom field B1, a frame F2 is comprised of the top field T2 and the bottom field B2, a frame F3 is comprised of the top field T3 and the bottom field B4, and a frame F4 is comprised of the top field T4 and the bottom field B4. It is assumed that these fields T1, B1, T2, B2, T3, B3, T4, B4 . . . are sequentially supplied to the frame synchronizer 10 along a time axis.

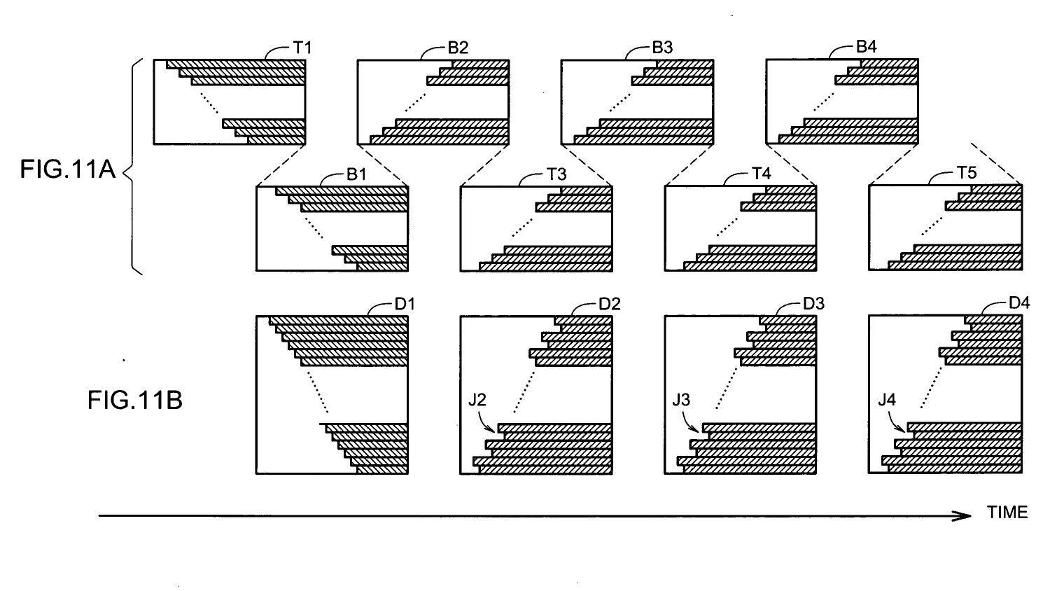

When the remaining capacity of the first buffer memory 13A reaches the lower limit immediately after the first buffer memory 13A stores the bottom field B1, the top field T2 is skipped by the field drop procedure (step S4). In the conventional frame synchronizer, when the top field T2 is skipped, as shown in FIG. 11A, the positions on the time axis shift between a group of the top fields T3, T4 and T5 and a group of the bottom fields B2, B3 and B4. Accordingly, as shown FIG. 11B, a displayed frame D1 is comprised of the top field T1 and the bottom field B1. A displayed frame D2 is comprised of the bottom field B2 and the top field T3, a displayed frame D3 is comprised of the bottom field B3 and the top field T4, and a displayed frame D4 is comprised of the bottom field B4 and the top field T5. Therefore, image edges J2, J3 and J4 appear jagged in the displayed frames D2, D3 and D4, respectively.

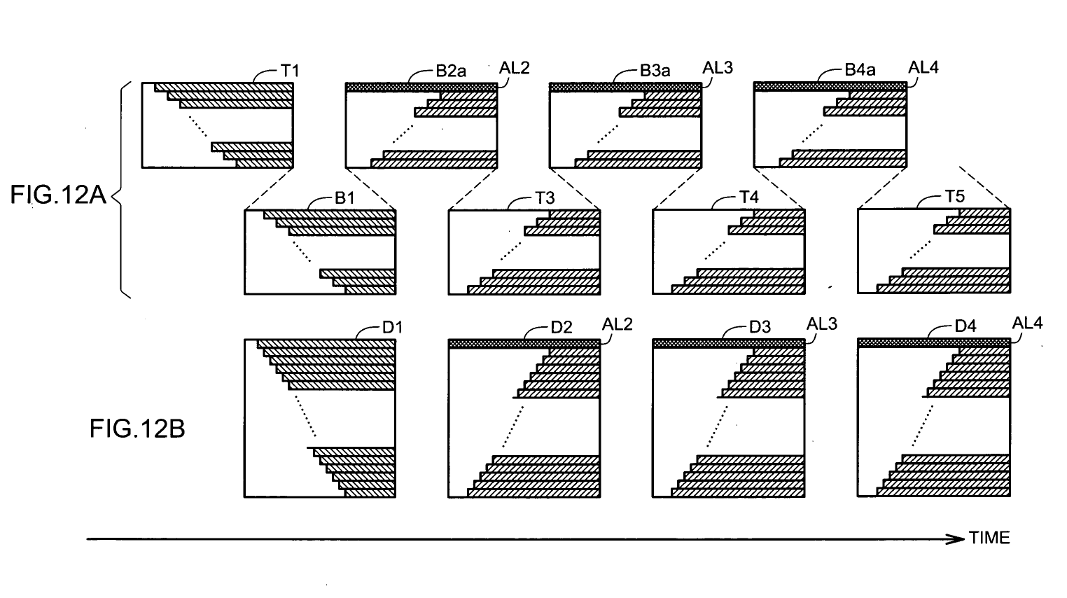

In the frame synchronizer 10 of the present embodiment, on the other hand, when the top field T2 is skipped, the selected active area BF2 of the bottom field as shown in FIG. 5B is selected (steps S38 to S41). The area BF2 is an area which is shifted one line upward from the selected active area BF1 (FIG. 5A) that is selected as a default. This is substantially the same as when pixel data for one horizontal line is added on the selected active area BF1 of the default, and lower one horizontal line of the selected active area BF1 is deleted. As FIG. 12A shows, the bottom fields B2a, B3a and B4a in which the horizontal lines AL2, AL3 and AL4 are added on the fields B2, B3 and B4 are generated. Accordingly, as shown in FIG. 12B, a displayed frame D1 is comprised of the top field T1 and the bottom field B1, a displayed frame D2 is comprised of the bottom field B2a and the top field T3, a displayed frame D3 is comprised of the bottom field B3a and the top field T4, and a displayed frame D4 is comprised of the bottom field B4a and the top field T5. Therefore, the position shift on the time axis is compensated, thereby to prevent the generation of jaggy.

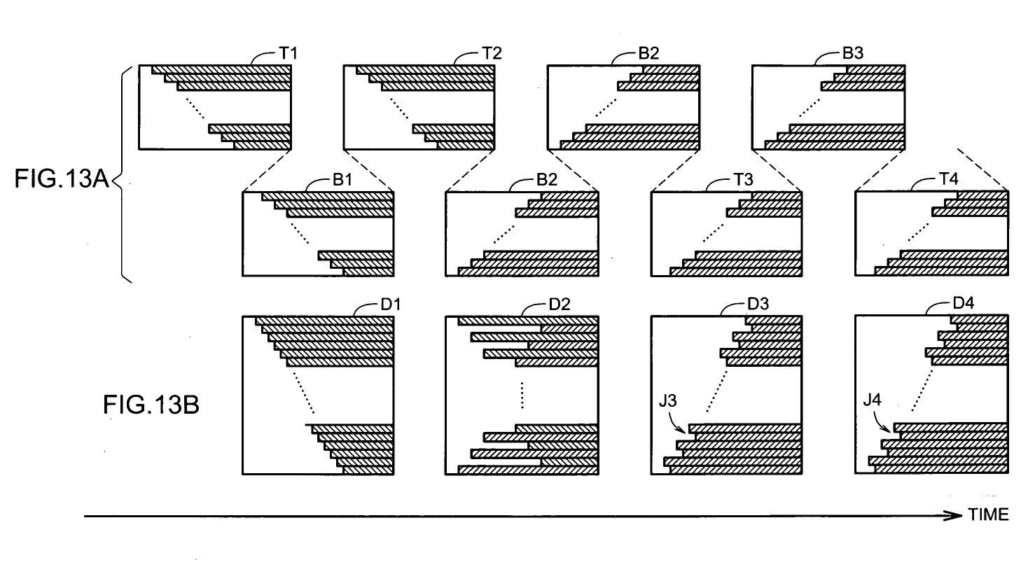

In FIG. 10, when the remaining capacity of the first buffer memory 13A reaches the upper limit immediately after the first buffer memory 13A stores the top field T2, the bottom field B2 is repeatedly read by the field insertion procedure (step S5). In the conventional frame synchronizer, when the bottom field B2 is repeatedly read, as shown in FIG. 13A, the positions on the time axis shift between a group of the bottom fields B2 and B3 and a group of the top fields T3 and T4. Accordingly, as FIG. 13B shows, a displayed frame D1 is comprised of the top field T1 and the bottom field B1, and a displayed frame D2 is comprised of the top field T2 and the bottom field B2. However, a displayed frame D3 is comprised of the bottom field B2 and the top field T3, and a displayed frame D4 is comprised of the bottom field B3 and the top field T4. Therefore, image edges J3 and J4 appear jagged in the displayed frames D3 and D4, respectively.

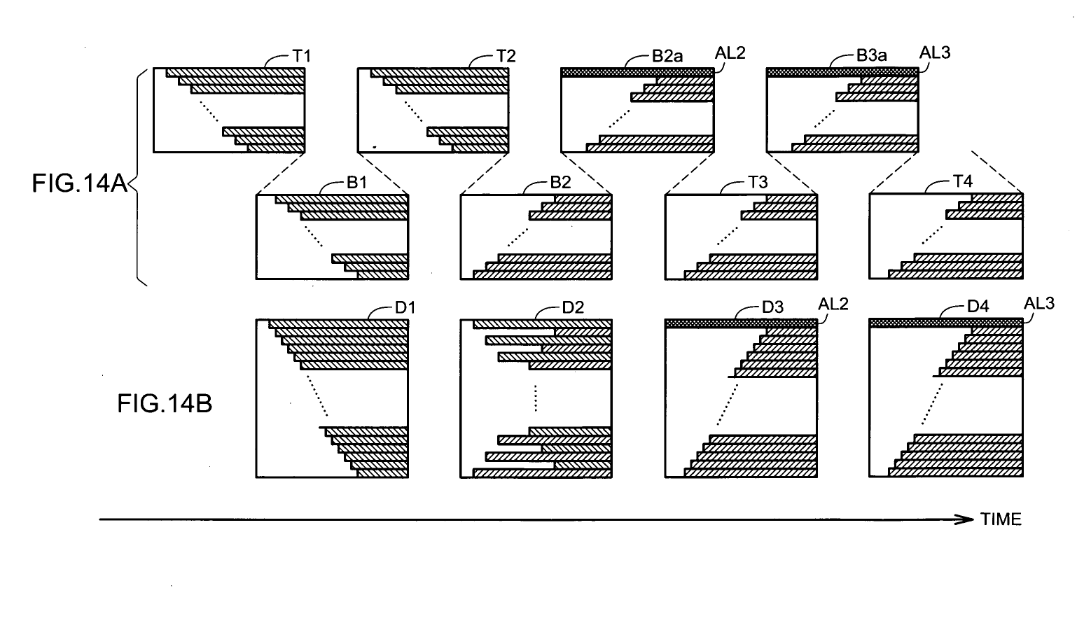

In the frame synchronizer 10 of the present embodiment, on the other hand, when the bottom field B2 is repeatedly read, the selected active area BF2 corresponding to the bottom field as shown in FIG. 5B is selected (steps S38 to S41). The selected active area BF2 is shifted one horizontal line upward from the selected active area BF1 (FIG. 5A) that is selected as a default. This is substantially the same as when pixel data for one horizontal line is added on the selected active area BF1 of the default, and lower one horizontal line of the selected active area BF1 is deleted. As shown in FIG. 14A, the bottom fields B2a and B3a in which the horizontal lines AL2 and AL3 are added on the fields B2 and B3 are generated. Accordingly, as shown in FIG. 14B, a displayed frame D1 is comprised of the top field T1 and the bottom field B1, a displayed frame D2 is comprised of the top field T2 and the bottom field B2, a displayed frame D3 is comprised of the bottom field B2a and the top field T3, and a displayed frame D4 is comprised of the bottom field B3a and the top field T4. Therefore, the position shift on the time axis is compensated, thereby to prevent the generation of jaggy.

As described above, according to the frame synchronizer 10 of the present embodiment, even if one field of the top field and the bottom field is skipped by the field drop procedure (step S4), when the other field is read from the buffer memory 13, the other field can be read from the start line that is shifted one horizontal line from the start line of a default (FIGS. 4B to 4C, 5B and 5C; the line selection procedure of FIG. 9). Also even if one field of the top field and the bottom field is repeated by the field insertion procedure (step S5), when the other field is read from the buffer memory 14, the other field can be read from the line that is shifted one horizontal line from the start line of the default (FIGS. 4B, 4C, 5B and 5C; line selection procedure in FIG. 9). Therefore, the generation of jaggy can be reduced.

Additionally, compared with the prior art in which the display images are shifted on a frame to frame basis by frame synchronization processing, the frame synchronizer of the present embodiment is capable of shifting display images on a field to field basis by the field drop procedure and field insertion procedure. Thus, the user recognizes the shift during only half of the display time of one frame (about 1/30 seconds in the NTSC system). Therefore, the synchronization processing of the present embodiment can suppress the deterioration of image quality, compared with the prior art.

Further, compared with the conventional frame synchronizer which requires a buffer memory having a storage capacity of at least two frames, the frame synchronizer 10 of the present embodiments needs only a buffer memory 4 that has a storage capacity of one field and two or three horizontal lines. Therefore, the frame synchronizer 10 enables the capacity of the buffer memory to be decreased, the reduction of the manufacturing cost and low power consumption.

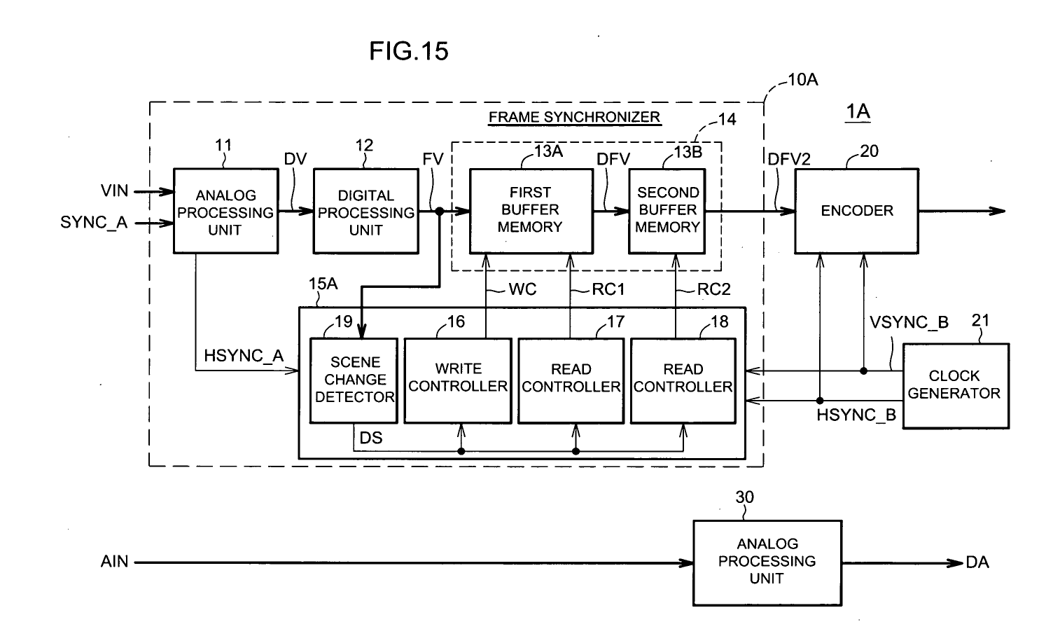

A modification of the above embodiment will be described. FIG. 15 is a block diagram depicting a configuration of an image processing apparatus 1A that comprises a frame synchronizer 10A according to the modification. It is understood that identical blocks in FIGS. 15 and 3 are referred to by the same reference numeral and have the same function. The detailed description of the identical blocks will be omitted. The frame synchronizer 10A of the modification is capable of detecting a scene change based on a data stream FV, and supplies the detection signal DS to a write controller 16, a read controller 17 and a read controller 18, which is different from the above embodiment.

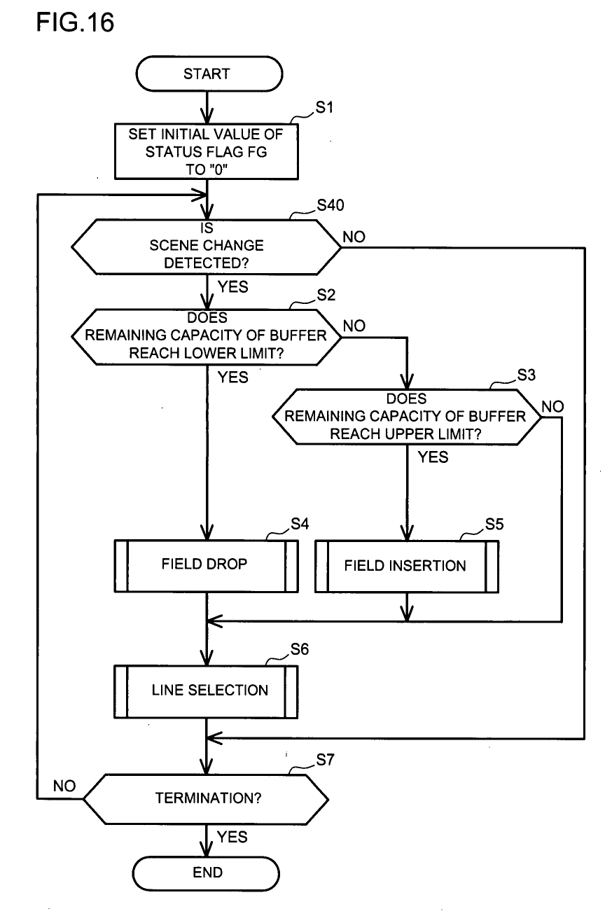

FIG. 16 is a flow chart depicting an example of a processing procedure according to a synchronization method of the modification. It is understood that identical blocks in FIGS. 16 and 6 are referred to by the same step number and have the same procedure. The detailed description of the identical blocks will be omitted. As shown in FIG. 16, a controller 15 sets an initial value of the status flag FG to “0” (step S1), then judges whether or not a scene change is detected by a scene change detector 19 (step S40). When the scene change is not detected, the procedure moves to step S7. Only when the scene change is detected, steps S2 to S6 are executed.

According to the modification, the field drop procedure (step S4), field insertion procedure (step S5) and line selection procedure (step S6) are executed when the scene change occurs, so that these procedures are executed almost together with the scene change. It is to be noted that the scene change frequently occurs. When the scene change does not occur, the number of times of these procedures can be decreased. Therefore, the deterioration of image quality can be suppressed at minimum.

The present application is based on Japanese Patent Application No. 2005-131114, which is hereby incorporated by reference.

1. A frame synchronizer for converting an input video data stream supplied in synchronization with a first synchronization signal, into an output video data stream synchronized with a second synchronization signal, said frame synchronizer comprising:
a buffer memory for storing said input video data stream; and
a memory control section for reading output video data from said buffer memory in synchronization with said second synchronization signal, wherein:
before a remaining capacity of said buffer memory reaches a predetermined lower limit, said memory control section reads one field of a first field and a second field in an area starting from a predetermined start line, and reads the other field in an area starting from a predetermined first start line, said first field containing pixel data on even number horizontal lines of each frame of said input video data stream, and said second field containing pixel data on odd number horizontal lines of said each frame; and
when said remaining capacity reaches said predetermined lower limit, said memory control section reads only the other field in an area starting from a second start line that is shifted by one horizontal line from said predetermined first start line.

2. The frame synchronizer according to claim 1, wherein, after the remaining capacity of said buffer memory reaches said predetermined lower limit, said memory control section reads one field of said first and second fields in an area starting from said predetermined start line, and reads the other field in an area starting from said second start line.

3. The frame synchronizer according to claim 1, wherein, when said remaining capacity of said buffer memory reaches said predetermined lower limit, one horizontal line of pixel data is added to the read field from said buffer memory.

4. The frame synchronizer according to claim 1, wherein:
before the remaining capacity of said buffer memory reaches a predetermined upper limit, said memory control section reads said first and second fields in an area starting from a predetermined start line; and
when the remaining capacity of said buffer memory reaches said predetermined upper limit, said memory control section reads one field of said first and second fields repeatedly from said buffer memory in an area starting from a third start line that is shifted by one horizontal line from said predetermined start line.

5. The frame synchronizer according to claim 4, wherein, after the remaining capacity of said buffer memory reaches said predetermined upper limit, said memory control section reads one field of said first and second fields in an area starting from said third start line, and reads the other field in an area starting from said predetermined start line.

6. The frame synchronizer according to claim 4, wherein, when the remaining capacity of said buffer memory reaches said predetermined upper limit, one horizontal line of pixel data is added to the read field from said buffer memory.

7. The frame synchronizer according to claim 1, wherein said buffer memory includes:
a field memory for alternately storing said first and second fields, and
a line memory for temporarily storing pixel data outputted from said field memory only by a predetermined number of horizontal lines, and
wherein said memory control section includes:
a first read controller for, when the remaining capacity of said field memory reaches said predetermined lower limit, reading only said other field by skipping over a storage area corresponding to said one field and supplying a read address that specifies a storage area corresponding to said other field, to said field memory; and
a second read controller for, when the remaining capacity of said field memory reaches said predetermined lower limit, reading said other field in an area starting from said second start line from said line memory.

8. The frame synchronizer according to claim 4, wherein said buffer memory includes:
a field memory for alternately storing said first and second fields; and
a line memory for temporarily storing pixel data outputted from said field memory only by a predetermined number of horizontal lines, and
wherein said memory control section includes:
a first read controller for, when the remaining capacity of said field memory reaches said predetermined upper limit, repeatedly reading said other field by repeatedly supplying a read address that specifies a storage area corresponding to said other field, to said field memory; and
a second read controller for, when the remaining capacity of said field memory reaches said predetermined upper limit, reading said other field in an area starting from said third start line from said line memory.

9. The frame synchronizer according to claim 1, further comprising a scene change detector for detecting a scene change of said input video data stream, wherein,
when the remaining capacity of said buffer memory reaches said predetermined lower limit and said scene change is detected, said memory control section reads only said other field in an area starting from said second start line.

10. The frame synchronizer according to claim 7, further comprising a scene change detector for detecting a scene change of said input image data stream, wherein,
when the remaining capacity of said buffer memory reaches said predetermined lower limit and said scene change is detected, said memory control section reads only said other field in an area starting from said second start line.

11. The frame synchronizer according to claim 4, further comprising a scene change detector for detecting a scene change of said input video data stream, wherein,
when the remaining capacity of said buffer memory reaches the upper limit and said scene change is detected, said memory control section reads repeatedly said other field in an area starting from said third start line from said buffer memory.

12. The frame synchronizer according to claim 8, further comprising a scene change detector for detecting a scene change of said input video data stream, wherein,
when the remaining capacity of said buffer memory reaches said predetermined upper limit, and said scene change is detected, said memory control section reads repeatedly said other field in an area starting from said third start line from said buffer memory.

13. The frame synchronizer according to claim 1, wherein said memory control section reads a field comprised of pixel data on a multiple of a power of 2 horizontal lines selectively from said buffer memory.

14. An image processing apparatus comprising:
a frame synchronizer according to claim 1; and
an encoder for encoding an output video data stream converted by said frame synchronizer.

15. A synchronization method for a frame synchronizer comprising a buffer memory for storing an input video data stream supplied in synchronization with a first synchronization signal to convert said input video data stream into an output video data stream synchronized with a second synchronization signal by reading video data from said buffer memory in synchronization with said second synchronization signal, said synchronization method comprising the steps of:
(a) before a remaining capacity of said buffer memory reaches a predetermined lower limit, reading one field of a first field and a second field in an area starting from a predetermined start line, and reading the other field in an area starting from a predetermined first start line, said first field containing pixel data on even number horizontal lines of each frame of said input video data stream, and said second field containing pixel data on odd number horizontal lines of said each frame; and
(b) when said remaining capacity reaches said predetermined lower limit, reading only the other field in an area starting from a second start line that is shifted by one horizontal line from said predetermined first start line.

16. The synchronization method according to claim 15, further comprising the steps of:
before the remaining capacity of said buffer memory reaches a predetermined upper limit, reading said first and second fields in an area starting from a predetermined start line; and
when the remaining capacity of said buffer memory reaches said predetermined upper limit, reading one field of said first and second fields repeatedly from said buffer memory in an area starting from a third start line that is shifted by one horizontal line from said predetermined start line.

17. A frame synchronization program for causing a microprocessor to execute synchronization processing to convert an input video data stream into an output video data stream synchronized with a second synchronization signal in a frame synchronizer having a buffer memory for storing said input video data stream supplied in synchronization with a first synchronization signal by reading video data from said buffer memory in synchronization with said second synchronization signal, said synchronization processing comprising the steps of:
(a) before a remaining capacity of said buffer memory reaches a predetermined lower limit, reading one field of a first field and a second field in an area starting from a predetermined start line, and reading the other field in an area starting from a predetermined first start line, said first field containing pixel data on even number horizontal lines of each frame of said input video data stream, and said second field containing pixel data on odd number horizontal lines of said each frame; and
(b) when said remaining capacity reaches said predetermined lower limit, reading only the other field in an area starting from a second start line that is shifted by one horizontal line from said predetermined first start line.

18. The frame synchronization program according to claim 17, wherein said synchronization processing further comprises the steps of:
before the remaining capacity of said buffer memory reaches a predetermined upper limit, reading said first and second fields in an area starting from a predetermined start line; and
when the remaining capacity of said buffer memory reaches said predetermined upper limit, reading one field of said first and second fields repeatedly from said buffer memory in an area starting from a third start line that is shifted by one horizontal line from said predetermined start line.
